(19) United States
(12) Patent Application Publication
(10) Pub. No.: US 2010/0025534 A1
(43) Pub. Date: Feb. 4, 2010

(54) Envelope For Lighter-Than-Air Aircraft

(76) Inventor: Adam N. Chu, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 12/182,827

(22) Filed: Jul. 30, 2008

(51) Int. Cl. B64B 1/58

(52) U.S. Cl. 244/128

(57) ABSTRACT

An envelope is disclosed for holding gas in a lighter-than-air aircraft. The envelope includes a shell having a leading edge, a trailing edge, an upper surface and a lower surface. The upper surface and the lower surface each extend between the leading edge and the trailing edge. The shell has an airfoil-shaped cross-section having a reflex camber quality.

### RELATED APPLICATIONS

This application claims the benefit of U.S. patent application Ser. No. 11/741,280, filed on Apr. 27, 2007.

### BACKGROUND OF THE INVENTION

Lighter-than-air aircraft take many forms and have a variety of uses. Primary uses for unmanned high altitude lighter-than-air aircraft are for surveillance and communications. Often, it is desirable that these aircraft maintain their position, or station keep.

Traditionally, these high altitude aircraft fly below 70,000 feet. It would be greatly advantageous to fly above 70,000 feet to be above atmospheric turbulence and disruptive weather, and to deconflict from commercial, private, and military fixed wing aircraft. However, at altitudes above 70,000 feet, strong winds are present. In order to station keep in these strong winds, it is highly useful for the aircraft to have a low aerodynamic drag.

### DESCRIPTION OF THE DRAWINGS

FIG. 1 is a perspective view of the envelope of the present invention.

FIG. 2 is a side elevation of the envelope of the present invention.

FIG. 3 is a top elevation of the envelope of the present invention.

FIG. 4 is a front elevation of the envelope of the present invention.

FIG. 5 is an exploded view of the side elevation of FIG. 2.

FIG. 6 is a front perspective view of an alternate embodiment of the present invention.

FIG. 7 is a rear perspective view of the embodiment of FIG. 6.

FIG. 8 is a cross sectional view of the embodiment of FIG. 6.

FIG. 9 is a bottom elevation of the embodiment of FIG. 6.

### DETAILED DESCRIPTION OF THE INVENTION

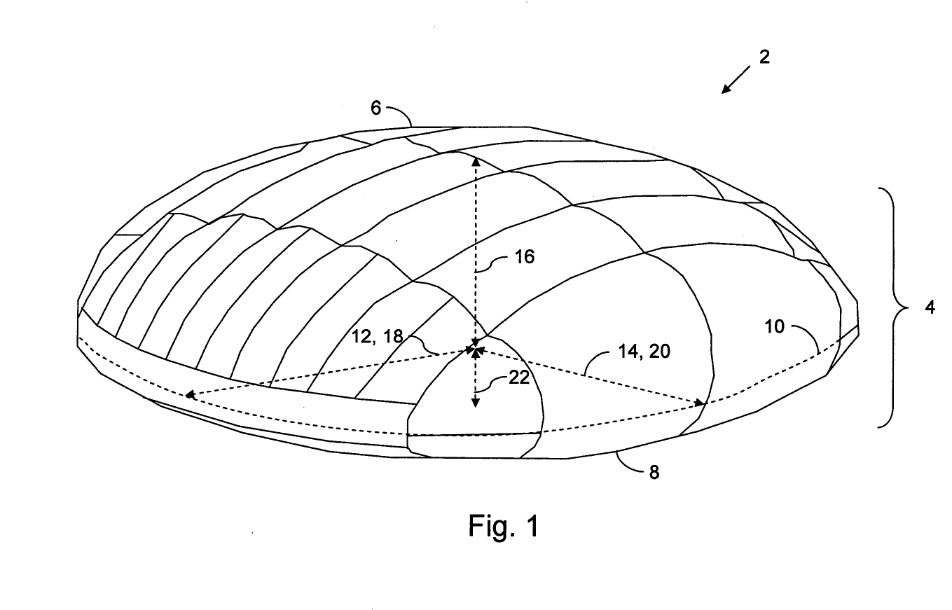

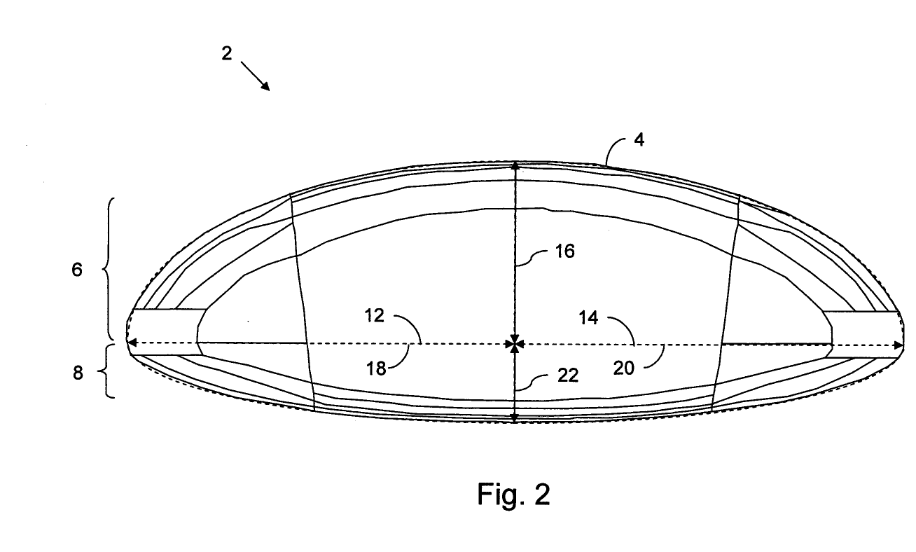

FIGS. 1-4 illustrates envelope 2 for holding gas in a lighter-than-air aircraft. Envelope 2 includes a shell 4. Shell 4 has an upper hemisphere 6 and a lower hemisphere 8 divided by equator 10.

Upper hemisphere 6 has the shape of a hemisphere of a generally oblate spheroid defined by equatorial radii 12, 14 and polar radius 16. In an oblate spheroid, polar radius 16 is less than equatorial radii 12, 14 and equatorial radii 12, 14 are equal to one another. Upper hemisphere 6 may be truly oblate, or may deviate from truly oblate. In one embodiment, upper hemisphere 6 deviates from truly oblate with one equatorial radius 12 being longer than the other equatorial radius 14. In one embodiment, the ratio of the smaller equatorial radius 14 to the larger equatorial radius 12 is between 0.75 and 1. For example, the ratio of the smaller equatorial radius 14 to the larger equatorial radius 12 may be 0.9. In the context of the present invention, a ratio in the range of between 0.75 and 1 is defined to be about equal.

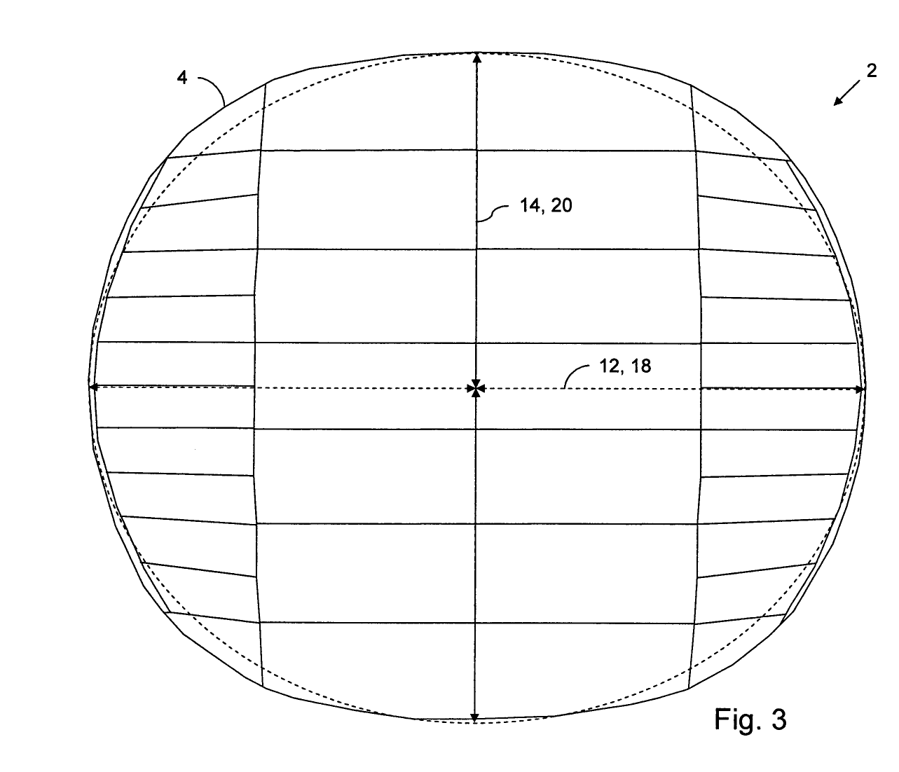

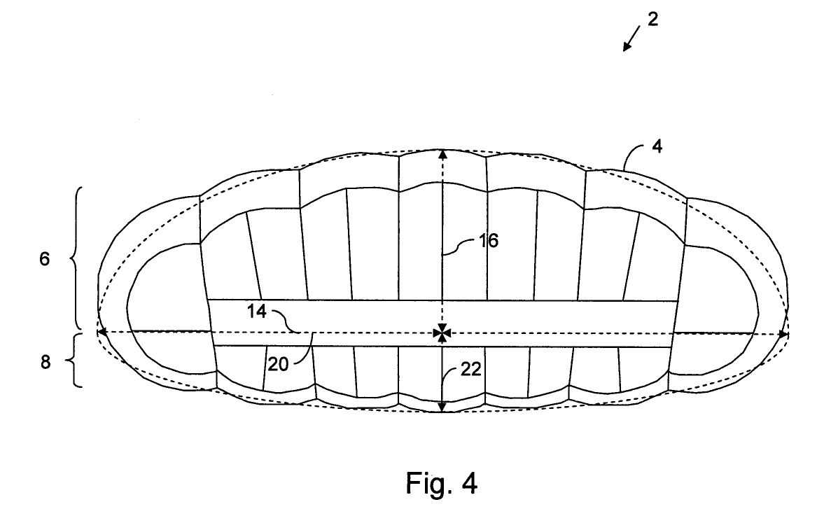

In another embodiment, upper hemisphere 6 deviates from truly oblate by extending beyond the boundaries of a perfect oblate spheroid hemisphere, as best seen in FIGS. 3 and 4. The dashed lines represent the boundaries of a generally oblate spheroid with one equatorial radius 12 longer than the other equatorial radius 14. It can be seen that, although the boundaries of shell 4 do not exactly match the boundaries of the oblate spheroid, the boundaries are substantially close.

Lower hemisphere 8 has the shape of a hemisphere of a generally oblate spheroid defined by equatorial radii 18, 20 and polar radius 22. Similar to upper hemisphere 6, lower hemisphere 8 is generally oblate and may not be exactly oblate. Additionally, equatorial radii 12, 14 of upper hemisphere 6 are equal to the equatorial radii 18, 20 of lower hemisphere 8. Lower hemisphere 8 is inverted compared to upper hemisphere 6 and is joined with upper hemisphere 6 at their respective equators 10.

The volume of one hemisphere of an oblate spheroid may be represented by the equation V=4/6 πabc, where a, b, and c are the equatorial radii and the polar radius. In the present invention, the volume of upper hemisphere 6 is greater than the volume of lower hemisphere 8. In one embodiment, the ratio of the volume of upper hemisphere 6 to the volume of lower hemisphere 8 is between 1.2 and 4. For example, the ratio of the volume of upper hemisphere 6 to the volume of lower hemisphere 8 may be 2.3.

The diameter of shell 4 may be represented by doubling an equatorial radius 12, 14, 18, 20. The height of shell 4 may be represented by adding the polar radius 16 of upper hemisphere 6 with the polar radius of lower hemisphere 8. In one embodiment, the height of shell 4 is less than the diameter of shell 4 at the joined equators 10. In one embodiment, the ratio of the diameter of shell 4 to the height of shell 4 is between 2.5 and 5. For example, the ratio of the diameter of shell 4 to the height of shell 4 may be 3.3.

Furthermore, an angle of shell 4 may be calculated from equatorial radii 12, 14, 18, 20 and polar radii 16, 22. The angle of the upper hemisphere is equal to the inverse tangent of polar radius 16 divided by one of the equatorial radii 12, 14. Similarly, the angle of the lower hemisphere is equal to the inverse tangent of polar radius 22 divided by one of the equatorial radii 18, 20. Adding the angles of the upper and lower hemispheres together, yields the angle of shell 4. In one embodiment, the angle of shell 4 is less than or equal to 40 degrees.

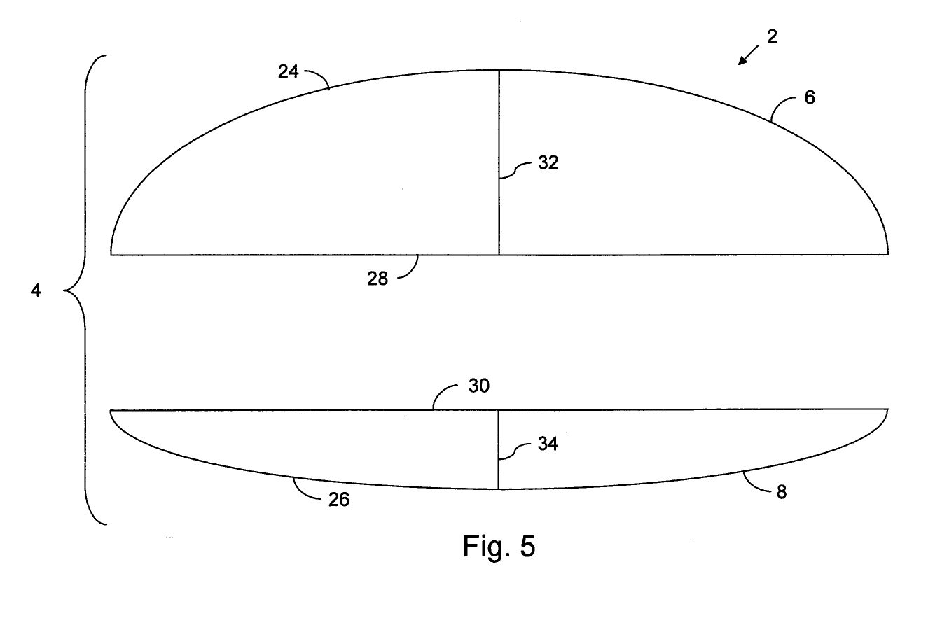

Since upper 6 and lower 8 hemispheres are shaped as generally oblate spheroids, envelope 2 may be alternatively described with reference to a cross section of shell 4 traversing the upper and lower hemispheres. In this description, the cross section includes two ellipse halves joined at their major axes. FIG. 5 best illustrates this description. One half of an ellipse 24 defines the shape of upper hemisphere 6. One half of another ellipse 26 defines the shape of lower hemisphere 8. Each of these half ellipses 24, 26 is divided along its major axis 28, 30. The major axes 28, 30 of the ellipses 24, 26 are equal, the semi-minor axes 32, 34 of the ellipses are unequal, and the ellipse 24, 26 halves are joined at their major axes 28, 30.

Since upper 6 and lower 8 hemispheres are shaped as generally oblate spheroids and the equatorial radii 12, 14 are equal to equatorial radii 18, 20, the ratio of the volume of upper hemisphere 6 to the volume of lower hemisphere 8 is directly related to the ratio of the semi-minor axis of upper hemisphere 6 to the semi-minor axis of lower hemisphere 8. Therefore, in one embodiment the semi-minor axis of the upper hemisphere is greater than the semi-minor axis of the lower hemisphere and the ratio of the semi-minor axis of the upper hemisphere to the semi-minor axis of the lower hemisphere is between 1.2 and 4. For example, the ratio of the semi-minor axis of upper hemisphere 6 to the semi-minor axis of lower hemisphere 8 may be 2.3.

In a further embodiment, the semi-major axes, one half of the major axes 28, 30, are greater than the sum of the semi-minor axes 32, 34. In one embodiment, the ratio of the semi-major axes to the sum of the semi-minor axes is between 2.5 and 5. For example, the ratio of the semi-major axes to the sum of the semi-minor axes may be 3.3.

Shell 4 may be further defined with reference to a cross section through the equator of shell 4. This cross section is generally elliptical. In one embodiment, the generally elliptical cross section is defined by a major axis and a minor axis and the ratio of the minor axis to the major axis is between 0.75 and 1. For example, the ratio of the minor axis to the major axis may be 0.9

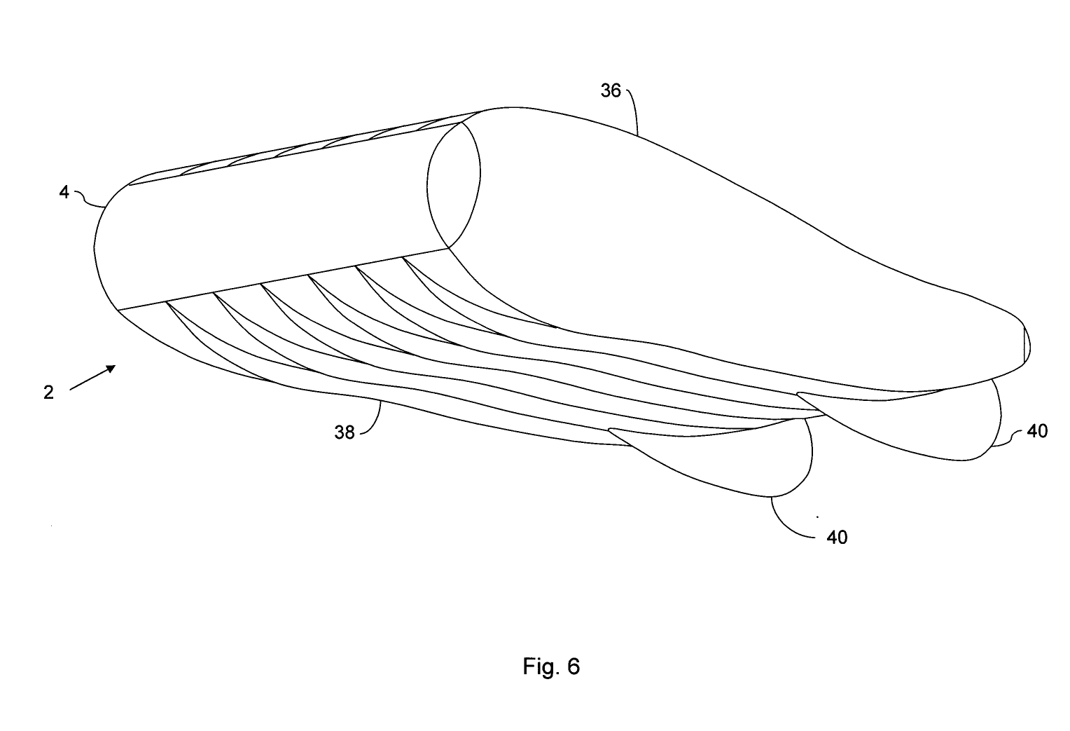

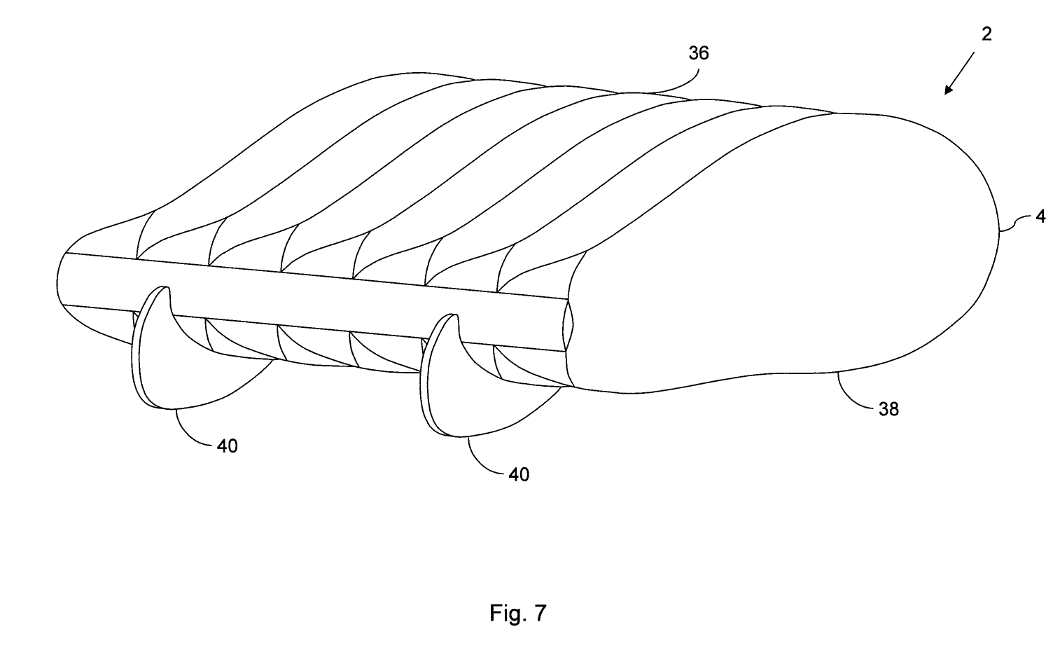

FIGS. 6 and 7 illustrate an alternate embodiment of envelope 2. In this embodiment, shell 4 has an upper shell component 36 and a lower shell component 38 instead of an upper hemisphere 6 and a lower hemisphere 8. Upper shell component 36 and lower shell component 38 together form shell 4. In one embodiment, the volume of upper shell component 36 is greater than the volume of lower shell component 38. Also shown in this embodiment are trailing edge fins 40, which help stabilize envelope 2.

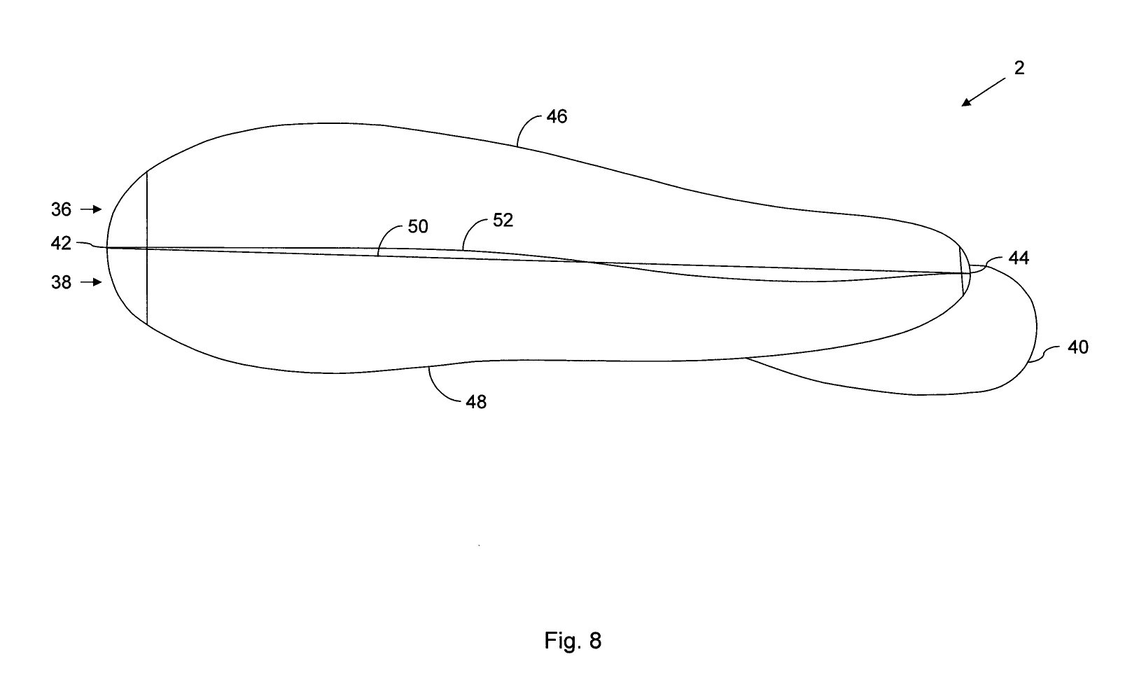

FIG. 8 is a cross-sectional diagram of shell 4 shown in FIGS. 6 and 7. In this cross section, it can be seen that shell 4 has an airfoil shape. The airfoil shape has a reflex camber quality.

Upper shell component 36 has leading edge 42, trailing edge 44, and upper surface 46. Upper surface 46 extends between leading edge 42 and trailing edge 44. Likewise, lower shell component 38 has leading edge 42, trailing edge 44, and lower surface 48. Lower surface 48 extends between leading edge 42 and trailing edge 44. Reference numbers for leading edge 42 and trailing edge 44 of upper 36 and lower 38 shell components are the same because the leading edge 42 and trailing edge 44 are the same for the upper 36 and lower 38 shell components and shell 4.

It can be seen from FIGS. 6-9 that circumscribing shell 4 through leading edge 42 and trailing edge 44 delineates upper shell component 36 and lower shell component 38. In one embodiment, the volume of upper shell component 36 is greater than the volume of lower shell component 38.

The chord of envelope 2 runs between the leading edge 42 and the trailing edge 44. The chord is represented by line 50. The camber of an envelope having an airfoil shape is the asymmetry between the curves of its upper 46 and lower 48 surfaces. Line 52 represent the camber of envelope 2 and illustrates a camber having a reflex quality. Line 52 is a reflex camber because, from leading edge 42 to trailing edge 44, camber line 52 initially curves upward, then downward, then back up again. The second upward curve is a reflex.

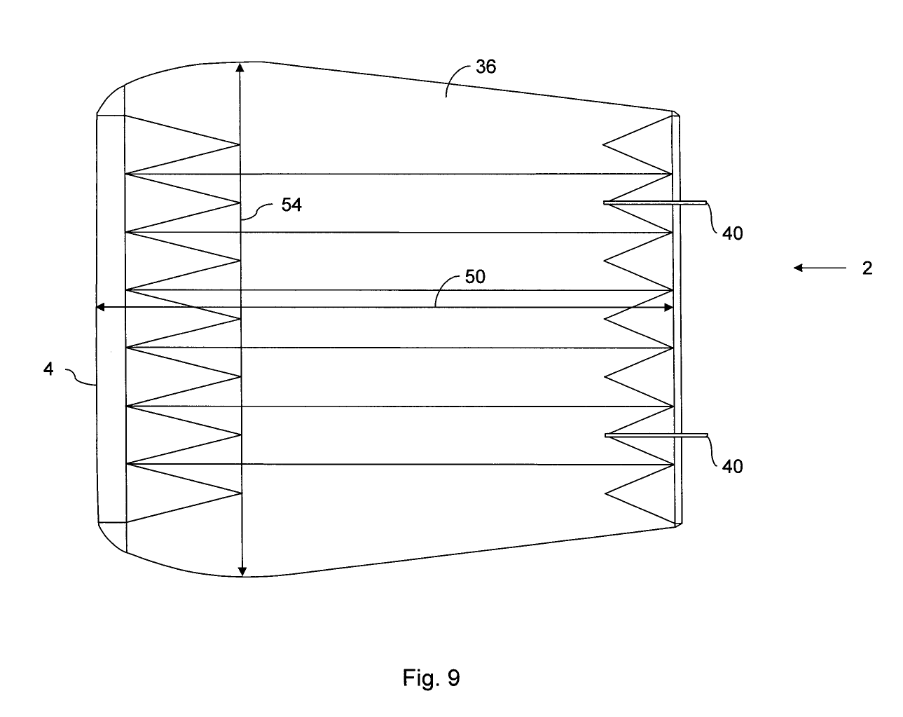

FIG. 9 is a bottom elevation of envelope 2. Illustrated in FIG. 9 is the generally rectangular shape of envelope 2, shell 4, and lower surface 48. Upper surface 46 has an identical outline to lower surface 48. It can be seen that, although the boundaries of shell 4 do not exactly match the boundaries of a rectangle, the boundaries are substantially close.

The span of envelope 2 runs across the width of envelope 2. Line 54 represents the span of envelope 2. In one embodiment, chord 52 of shell 4 is less than span 54 of shell 4.

The present invention is greatly advantageous over previous high altitude envelope solutions as it reduces drag, enabling a lighter-than-air aircraft using this envelope to maintain its position for a longer period of time, maneuver better, and transit longer distances than has been possible with other envelope designs.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. An envelope for holding gas in a lighter-than-air aircraft, the envelope comprising:
an upper shell component having a leading edge, a trailing edge, and an upper surface extending between the leading edge and the trailing edge;
a lower shell component having a leading edge, a trailing edge, and a lower surface extending between the leading edge and the trailing edge;
wherein the upper shell component and the lower shell component together form a shell having an airfoil-shaped cross-section, the airfoil shape having a reflex camber quality.

2. The envelope of claim 1 wherein the volume of the upper shell component is greater than the volume of the lower shell component.

3. The envelope of claim 1 wherein the chord of the shell is greater than the span of the shell.

4. The envelope of claim 1 wherein the upper surface and the lower surface are generally rectangular in shape.

5. An envelope for holding gas in a lighter-than-air aircraft, the envelope comprising:
a shell having
a leading edge,
a trailing edge,
an upper surface extending between the leading edge and the trailing edge, and
a lower surface extending between the leading edge and the trailing edge,
wherein the shell has an airfoil-shaped cross-section having a reflex camber quality.

6. The envelope of claim 5 wherein circumscribing the shell through the leading edge and the trailing edge delineates an upper shell component and a lower shell component and the volume of the upper shell component is greater than the volume of the lower shell component.

7. The envelope of claim 5 wherein the chord of the shell is greater than the span of the shell.

8. The envelope of claim 5 wherein the upper surface and the lower surface are generally rectangular in shape.
